(19) United States
(12) Patent Application Publication
(10) Pub. No.: US 2016/0196493 A1
(43) Pub. Date: Jul. 7, 2016

(54) Personal outdoor activity app system for wireless communications devices

(71) Applicant: Alex P. Glynn, Flemington, NJ (US)

(72) Inventor: Alex P. Glynn, Flemington, NJ (US)

(21) Appl. No.: 14/544,391

(22) Filed: Jan. 2, 2015

(51) Int. Cl. G06N 5/04; H04W 4/02

(52) U.S. Cl. CPC G06N 5/04; H04W 4/028

(57) ABSTRACT

A personal outdoor activity app system for wireless communications devices comprises: a) providing an app link to subscribers; b) upon activation of the app, identifying the subscriber by receiving a location ID and presenting a distance query that seeks the maximum distance that said subscriber desires to travel, wherein the subscriber may send a selected distance by a method from the group consisting of typing a distance, and selecting one of a plurality of offered, preset distances; c) locating and identifying all outdoor activity locations with the selected distance; d) procuring weather information relating to each outdoor activity within the selected distance of the subscriber; e) establishing a weather score for procured weather information and ranking each location in accordance with said weather score; f) presenting at least one list of all activity locations based on at least one criterion from (i) weather score; (ii) weather score and distance.

### REFERENCE TO RELATED APPLICATIONS

The present application is not related to any pending or issued United States of America or foreign patent or patent application.

### BACKGROUND OF INVENTION

a. Field of Invention

The present invention generally relates to an application, referred to in the industry as an “app”, for wireless communications devices. It has been developed to enable a subscriber (user) to quickly do the following on his/her wireless communications devices: chose a distance within which the subscriber wishes to travel (travel limits); procure all locations of a particular outdoor activity within the selected distance; procure ranking information to enable the subscriber to make an informed decision as to which location is most preferred, if any. The ranking information is based at least on weather reports, preferably real time weather, and may include traffic considerations, distance and even other location specific criteria, e.g., in the case of snowboarding, the slope conditions (depth of snow and type (packed power; icy; fresh powder)).

b. Description of Related Art

The following patents are representative of the field pertaining to the present invention:

U.S. Pat. No. 7,383,130 B1 to Vinod Koosam describes and illustrates a weather-based activity advisor that provides activity recommendations to a user based on location and a time parameters. The activity recommendations are based on assessments of the desirability of potential activities such as weather-based index values. The weather-based activity advisor may present recommended activities, facilities offering the activities, information about the activities, and information about weather conditions influencing the desirability of the activities. The activity advisor may also present supplemental information such as advertisements and related web links.

U.S. Pat. No. 7,602,285 B2 describes an automated weather alert system using GIS technology automatically ingests weather data and processes the weather data to determine if localized weather conditions pose a threat to any of a plurality of business operations, each of which have a known location. In the event such threat exists, an employee having responsibility for a threatened business operation is provided with an alert message and asked to acknowledge receipt. Additional notification is automatically provided to the employee's supervisor if such acknowledgment is not received within a predetermined period of time.

United States Patent Appl. Publication No. 2009/0316671 A1 to Rolf et al. discloses a transmitter that transmits time synchronized data via a pager/WiMax/802.x access to a receiver system, wherein the receiver system is programmed to receive data for specific geographic locations. The geographic locations may be specified by the user or by the receiver system, and includes state, zip codes, towns, counties, towns, or cardinal regions. The receiver is able to find its location when outside its cell region and is able to synchronize to the data transmitted in the new cell region. Further, the receiver system is able to remotely monitor weather data and other information at a different location via wireless Internet or voice over IP. A transceiver may also be used to receive weather or alert data. In response to receiving data, the transceiver transmits the data to low powered devices in a house using a different frequency band than the frequency band it received the data.

An App called EVERYTRAIL PRO advertised in TRAVEL+LEISURE, Jan. 14, 2014, page 62 describes a preferred activity input, such as mountain biking and offers a list of local routes. The list of local routes would include maps, trail suggestions and audio guides that highlight nearby sights in real time. This is different from the present invention, which gives suggestions on other locations with the distance for a given activity and also uses a weather score to determine the adequacy of the weather at the other locations. In addition, the traffic is also weighted. The EVERYTRAIL PRO would work well as an add-on to the present invention.

Notwithstanding the prior art, the present invention is neither taught nor rendered obvious thereby.

### SUMMARY OF INVENTION

The present invention is an application, referred to in the industry as an “app”, for wireless communications devices. It has been developed to enable a subscriber (user) to quickly do the following on his/her wireless communications devices: chose a distance within which the subscriber wishes to travel (travel limits); procure all locations of a particular outdoor activity within the selected distance; procure ranking information to enable the user to make an informed decision as to which location is most preferred, if any. The ranking information is based at least on weather reports, preferably real time weather, and may include traffic considerations, distance and even other location specific criteria, e.g., in the case of snowboarding, the slope conditions (depth of snow and type (packed power; icy; fresh powder)).

In some preferred embodiments of the present invention a personal outdoor activity app system for wireless communications devices, which comprises: a) providing an app link to subscribers that may be activated by selection of the app; b) upon activation of the app by a subscriber, identifying the subscriber by receiving a location ID and presenting a distance query to the subscriber that seeks the maximum distance that said subscriber desires to travel, wherein the subscriber may send a selected distance by a method selected from the group consisting of typing a distance, and selecting one of a plurality of offered, preset distances; c) locating and identifying all outdoor activity locations with the selected distance; d) procuring weather information relating to each location of an outdoor activity within the selected distance of said subscriber; e) establishing a weather score for procured weather information for each location and ranking each location in accordance with said weather score; f) presenting at least one orderly list of all outdoor activity locations based on at least one criterion selected from the group consisting of (i) weather score; (ii) weather score and distance.

In some preferred embodiments of the present invention a personal outdoor activity app system wherein the app further includes additional information for each location.

In some preferred embodiments of the present invention a personal outdoor activity app system wherein the app further includes presenting an outdoor activity query to the subscriber to identify the desired outdoor activity.

In some preferred embodiments of the present invention a personal outdoor activity app system wherein the app is dedicated to one specific outdoor activity. In some preferred embodiments of the present invention a personal outdoor activity app system of claim 1 wherein the app is dedicated to swimming and the locations are beaches.

In some preferred embodiments of the present invention a personal outdoor activity app system wherein the app is dedicated to skiing and snowboarding and the locations are ski and snowboard areas.

In some preferred embodiments of the present invention a personal outdoor activity app system wherein the app further provides slope conditions with each location.

In some preferred embodiments of the present invention a personal outdoor activity app system wherein the app is dedicated to golfing and the locations are golf facilities.

In some preferred embodiments of the present invention a personal outdoor activity wherein said weather information includes wind speed and direction for each location.

In some preferred embodiments of the present invention a personal outdoor activity app system, wherein the app further includes a selection option enabling a subscriber to select a location to obtain further information selected from the group consisting of at least one of: (1) a telephone number; (ii) a website; (iii) an address; (iv) travel directions; and (v) discount coupon.

In some preferred embodiments of the present invention a personal outdoor activity app system for wireless communications devices, which comprises: a) providing an app link to subscribers that may be activated by selection of the app; b) upon activation of the app by a subscriber, identifying the subscriber by receiving a location ID and presenting a distance query to the subscriber that seeks the maximum distance that said subscriber desires to travel, wherein the subscriber may send a selected distance by a method selected from the group consisting of typing a distance, and selecting one of a plurality of offered, preset distances; c) locating and identifying all outdoor activity locations with the selected distance; d) procuring weather information relating to each location of an outdoor activity within the selected distance of said subscriber; e) procuring traffic information relating to each location of an outdoor activity within the selected distance of said subscriber; f) establishing a weather score for procured weather information for each location and ranking each location in accordance with said weather score; g) establishing a traffic score for procured traffic information for each location and ranking each location in accordance with said traffic score; h) presenting at least one orderly list of all outdoor activity locations based on one criterion selected from the group consisting of (i) two lists as follows: a separate weather list and a separate traffic list; and (ii) a single list based on combined weather scores and traffic scores; (iii) at least two lists as follows: a separate weather list and a separate traffic list and distance; and (ii) at least a single list based on combined weather scores and traffic scores, and distance.

In some preferred embodiments of the present invention a personal outdoor activity app system wherein the app further includes additional information for each location.

In some preferred embodiments of the present invention a personal outdoor activity app system wherein the app further includes presenting an outdoor activity query to the subscriber to identify the desired outdoor activity.

In some preferred embodiments of the present invention a personal outdoor activity app system wherein the app is dedicated to one specific outdoor activity.

In some preferred embodiments of the present invention a personal outdoor activity app system wherein the app is dedicated to swimming and the locations are beaches.

In some preferred embodiments of the present invention a personal outdoor activity app system wherein the app is dedicated to skiing and snowboarding and the locations are ski and snowboard areas.

In some preferred embodiments of the present invention a personal outdoor activity app system wherein the app further provides slope conditions with each location.

In some preferred embodiments of the present invention a personal outdoor activity app system wherein the app is dedicated to golfing and the locations are golf facilities.

In some preferred embodiments of the present invention a personal outdoor activity app system wherein said weather information includes wind speed and direction for each location.

In some preferred embodiments of the present invention a personal outdoor activity app system wherein the app further includes a selection option enabling a subscriber to select a location to obtain further information selected from the group consisting of at least one of: (1) a telephone number; (ii) a website; (iii) an address; (iv) travel directions; and (v) discount coupon.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a flow chart of various features of an embodiment of the present invention personal activity app system for wireless communication devices;

FIG. 2 shows a flow chart of various other features of an embodiment of the present invention personal activity app system for wireless communication devices shown in Figurel;

FIG. 3 shows a flow chart of various features of another embodiment of the present invention personal activity app system for wireless communication devices; and,

FIG. 4 shows a flow chart of various other features of the embodiment of the present invention personal activity app system for wireless communication devices shown in FIG. 3.

### DETAILED DESCRIPTION OF THE EMBODIMENTS

The present invention relates to a personal outdoor activity app system for wireless communication devices. A subscriber may obtain access to the link by selection of the App. As a subscriber, one has the capability to obtain a listing and location of all outdoor activities within a selected distance from where the subscriber is situated. Furthermore, a weather score is supplied for each location of an outdoor activity within a selected distance entered by the subscriber.

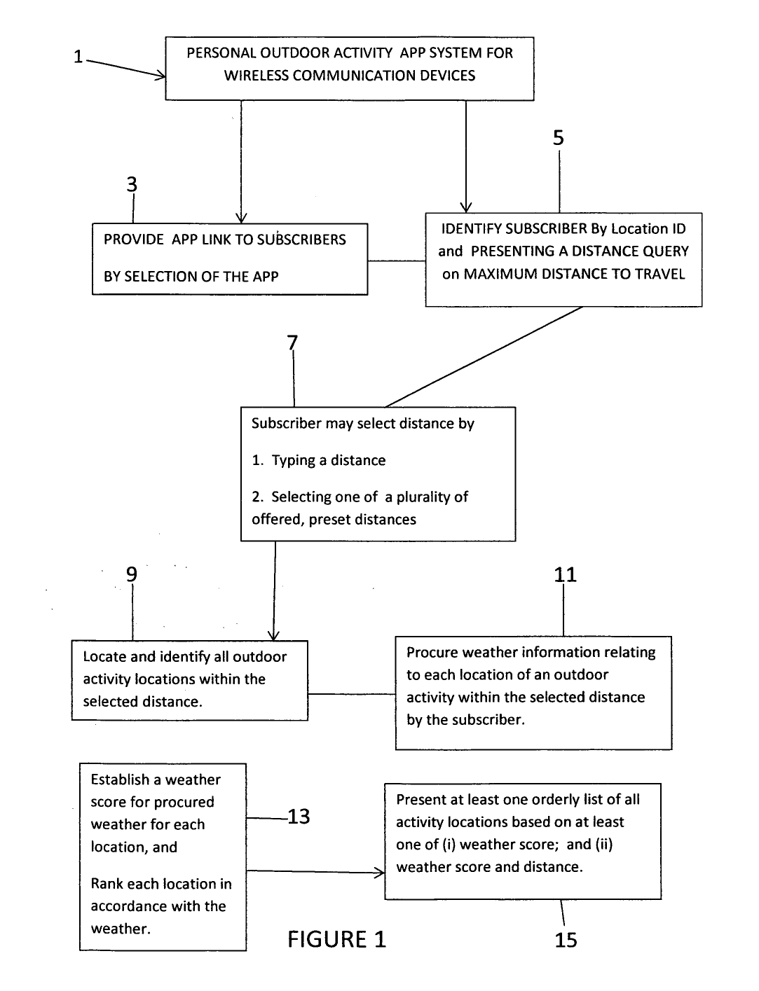

Referring to FIG. 1, there is shown a flow chart for a personal outdoor activity app system for wireless communication devices 1. A subscriber obtains access to the app link by selection of the app 3. The app system identifies the subscriber by location ID, which is calculated by the app system 5. The app system includes sufficient hardware and software to power all functions in the system. As soon as the app system identifies the subscriber, the app provides a query to the subscriber on the maximum distance to travel 5. In response to this query by the app system, the subscriber may select distance by typing a distance or selecting one of a plurality of offered, preset distances 7.

The app includes sufficient hardware and software to locate and identify all outdoor activity located within the selected distance 9. Because of this, weather information relating to each location of an outdoor activity within the selected distance by the subscriber 11 is procured. The app establishes a weather score for procured weather for each location and ranks each location in accordance with the weather 13. The app system will then present at least one orderly list of all activity locations based on at least one of (i) weather score, and (ii) weather score and distance 15.

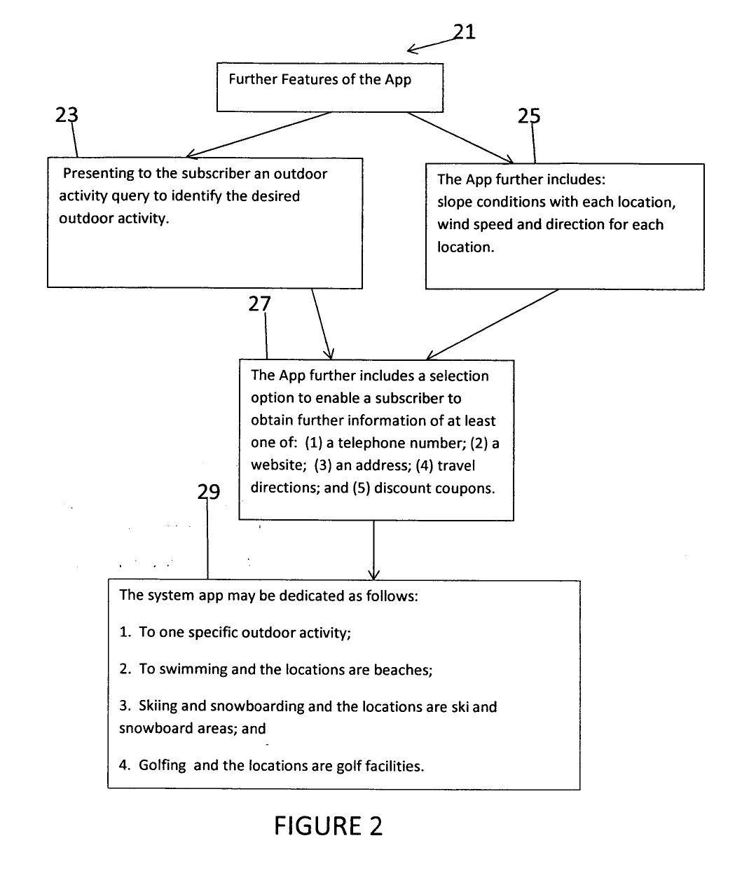

Referring now to FIG. 2, there is shown a flow chart of further features on the app system 21. Such features include additional information for each location. and further includes presenting an outdoor activity query to the subscriber to identify the desired outdoor activity 23.

The app may be dedicated to one specific outdoor activity 23. For example, the app may be dedicated to swimming and the locations are beaches 29. Or the app is dedicated to skiing and snowboarding and the locations are ski and snowboard areas 29. When the subscriber selects skiing and snowboarding, the app further provides slope conditions with each location 29. The app may be dedicated to golfing and the locations are golf facilities 29. The app may provide weather information which includes wind speed and direction for each location 25. The app may further include a selection option 27 enabling a subscriber to select a location to obtain further information selected from the group consisting of at least one of: (1) a telephone number; (ii) a website; (iii) an address; (iv) travel directions; and (v) discount coupons.

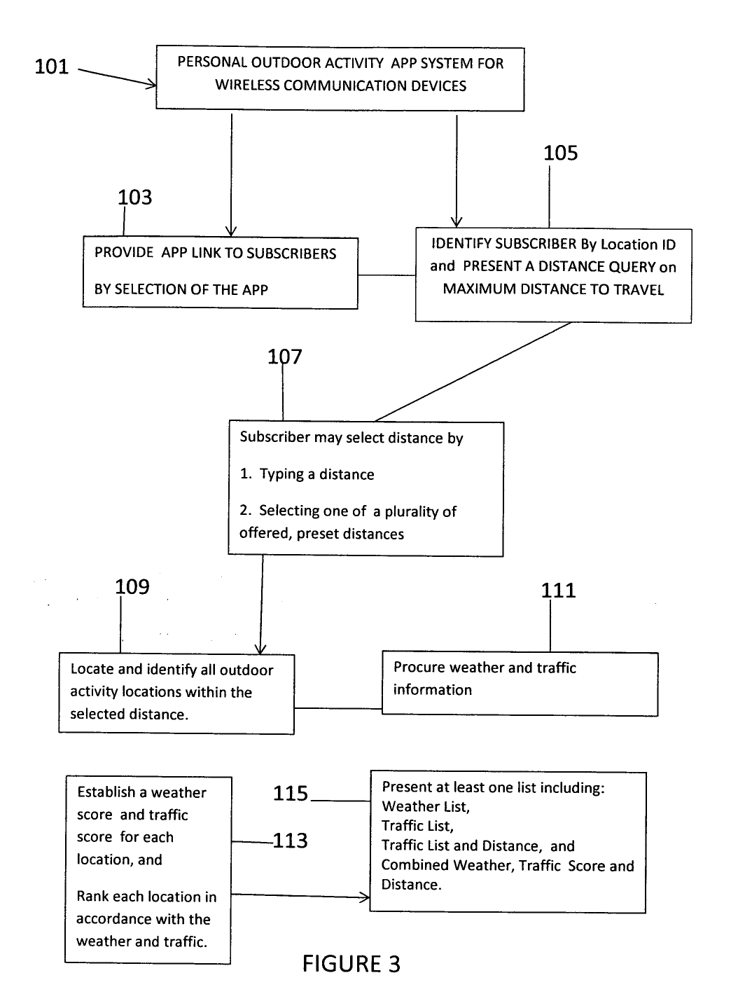

Referring now to FIG. 3, there is shown a flow chart for a personal outdoor activity app system for wireless communication devices 101. A subscriber obtains access to the app link by selection of the app 103. The app system identifies the subscriber by location ID, which is calculated by the system 105. The app system includes sufficient hardware and software to power all functions in the system. As soon as the app system identifies the subscriber, the app provides a query to the subscriber on the maximum distance to travel 105. In response to this query by the app system, the subscriber may select distance by typing a distance or selecting one of a plurality of offered, preset distances 107.

The app includes sufficient hardware and software to locate and identify all outdoor activity located within the selected distance 109. Because of this, weather information relating to each location of an outdoor activity within the selected distance 111 may be presented to the subscriber. The app establishes a weather score and traffic score for procured weather and traffic, respectively for each location 113 and ranks each location in accordance with the weather. In addition, a traffic score is established for procured traffic for each location 113 and ranks each location with the weather and traffic 113. The app system will then present at least one orderly list of all activity locations 115 which includes (i) two lists as follows: separate weather list and traffic list and; (ii) a single list based upon combined weather scores and traffic scores; (iii) at least two lists as follows: separate weather list and a separate traffic list and distance; and, (iv) at least a single list based or combined weather scores and traffic scores, and distance.

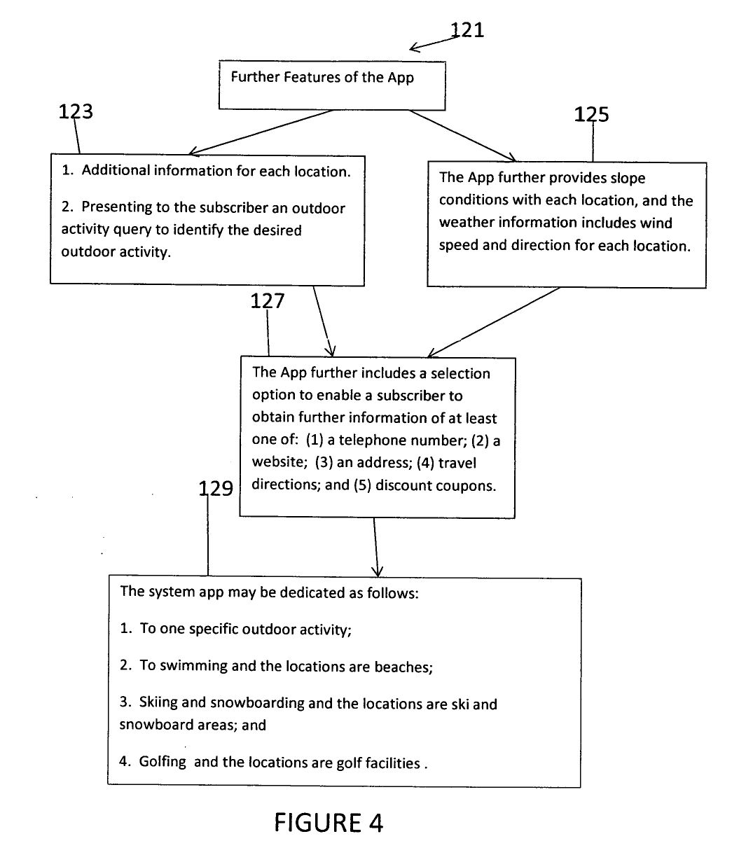

Referring now to FIG. 4, there is shown a flow chart of further features on the app system 121. Such features include additional information for each location. and further includes presenting an outdoor activity query to the subscriber to identify the desired outdoor activity 123.

The app may be dedicated to one specific outdoor activity 129. For example the app may be dedicated to swimming and the locations are beaches 129. Or the app is dedicated to skiing and snowboarding and the locations are ski and snowboard areas 129. When the subscriber selects skiing and snowboarding, the app further provides slope conditions with each location 129. The app may be dedicated to golfing and the locations are golf facilities 129. The app may provide weather information which includes wind speed and direction for each location 125. The app may further include a selection option 127 enabling a subscriber to select a location to obtain further information selected from the group consisting of at least one of: (1) a telephone number; (ii) a website; (iii) an address; (iv) travel directions; and (v) discount coupon.

The following examples are representative of the app system in use.

1. Using App for Beaches Application. A subscriber selects the app, and the system identifies the subscriber by location ID. In this example, the subscriber is in Lawrenceville, N.J. The system sends a query requesting a maximum distance to travel. The subscriber may type in a distance or select from one of a plurality of offered, preset distances. The user selects the preset distance of 100 miles and responds to an outdoor activity query to present beaches. The system supplies the weather score of beaches located within the distance desired to travel and presents a list of beaches based on weather score (1 being clear and beautiful while 5 means heavy, torrential rains) and traffic score (1 being the least traffic while 5 means extreme traffic) The list of beaches includes:

Jones Beach distance (75 miles) traffic score (1) weather score (2),

Point Pleasant distance (60 miles) traffic score (4) weather score (1),

Ortley Beach distance (65 miles) traffic score (3) weather score (3),

Wildwood distance (85 miles) traffic score (5) weather score (4), and,

Cape May distance (95 miles) traffic score (2) weather score (1).

The subscriber makes one's selection of Jones' Beach because it had better combined traffic and weather conditions, even though the traveling was more.

2. Using App for Golf Courses Application. A subscriber selects the app, and the system identifies the subscriber by location ID. In this example, the subscriber is in Lawrenceville, N.J. The system sends a query requesting a maximum distance to travel. The subscriber may type in a distance or select from one of a plurality of offered, preset distances. The user selects the preset distance of 40 miles and responds to an outdoor activity query to present golf courses. The system supplies the weather score of golf courses located within the distance desired to travel and presents a list of golf courses based on weather score, and weather score and distance, 1 being clear and beautiful while 5 means heavy rains. The list of golf courses includes:

Cranbury Golf Club distance (15 miles) weather score (3),

Meadows at Middlesex distance (30 miles) weather score (1),

Double Edge Golf distance (15 miles) weather score (3), and

Ridge at Back Brook distance (20 miles) weather score (4).

The subscriber chose Meadows at Middlesex because the weather was better.

3. Using App for Skiing and Snow Boarding Application. A subscriber selects the app, and the system identifies the subscriber by location ID. In this example, the subscriber is in Lawrenceville, N.J. The system sends a query requesting a maximum distance to travel. The subscriber may type in a distance or select from one of a plurality of offered, preset distances. The user manually enters at distance of 50 miles and responds to an outdoor activity query to present skiing and snowboarding. The system supplies the weather score of golf courses located within the distance desired to travel and presents a list of golf courses based on weather score, and weather score and distance, 1 being clear and beautiful while 5 means heavy rains. The list of skiing and snowboarding parks includes:

Camelback distance (90 miles) weather score (3),

Shawnee distance (70 miles) weather score (1),

Bear Creek Mountain Resort. distance (90 miles) weather score (4),

The subscriber chose Shawnee because the weather was better and the distance was less.

4. Using App for Weather and Traffic for Beach application. A subscriber selects the app, and the system identifies the subscriber by location ID. In this example, the subscriber is in Lawrenceville, N.J. The system sends a query requesting a maximum distance to travel. The subscriber may type in a distance or select from one of a plurality of offered, preset distances. The user selects the preset distance of 100 miles and responds to an outdoor activity query to present beaches. The system supplies the weather score of beaches courses located within the distance desired to travel and presents a list of beaches based on weather score, traffic score, and weighted average of weather and traffic score. The list of beaches includes:

Jones Beach distance (75 miles) weather score (2) traffic score (4), weighted 3

Point Pleasant distance (60 miles) weather score (3) traffic score (3), weighted (3)

Ortley Beach distance (65 miles) weather score (3) traffic score (4), weighted 3.5

Wildwood distance (85) weather score (2), traffic score (2), weighted 2, and

Cape May distance (95 miles) weather score (1), traffic score (3) weighted 2.

In this case, both the weather score and the traffic score are weighted by an average of the two. Wildwood and Cape May are the same for the weighted average. However, Wildwood is closer. Thus, the subscriber would choose Wildwood.

5. Using App for Skiing and Snow Boarding Application. A subscriber selects the app, and the system identifies the subscriber by location ID. In this example, the subscriber is in Lawrenceville, N.J. The system sends a query requesting a maximum distance to travel. The subscriber may type in a distance or select from one of a plurality of offered, preset distances. The user selects the preset distance of 100 miles and responds to an outdoor activity query to present skiing and snowboarding. The system supplies the weather score of golf courses located within the distance desired to travel and presents a list of golf courses based on weather score, and weather score and distance, 1 being clear and beautiful while 5 means heavy rains. Weighted score is also calculated by the app. The list of skiing and snowboarding parks includes:

Camelback distance (90 miles) weather score (3), traffic (4), weighted 3.5

Shawnee distance (70 miles) weather score (1), traffic (1), weighted 1.

Bear Creek Mountain Resort. distance (90 miles) weather score (4) traffic (4), weighted 4.

The subscriber chose Shawnee because the weighted score of traffic and weather was the best.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

While particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. While developed for outdoor use or outdoor exposure, it should be understood that the present invention can be used in any environment, such as a school, sports club or any other environment where lockers are employed.

What is claimed is:

1. A personal outdoor activity app system for wireless communications devices, which comprises:
a) providing an app link to subscribers that may be activated by selection of the app;
b) upon activation of the app by a subscriber, identifying the subscriber by receiving a location ID and presenting a distance query to the subscriber that seeks the maximum distance that said subscriber desires to travel, wherein the subscriber may send a selected distance by a method selected from the group consisting of typing a distance, and selecting one of a plurality of offered, preset distances;
c) locating and identifying all outdoor activity locations with the selected distance;
d) procuring weather information relating to each location of an outdoor activity within the selected distance of said subscriber;
e) establishing a weather score for procured weather information for each location and ranking each location in accordance with said weather score;
f) presenting at least one orderly list of all outdoor activity locations based on at least one criterion selected from the group consisting of (i) weather score; (ii) weather score and distance.

2. The personal outdoor activity app system of claim 1 wherein said app further includes additional information for each location.

3. The personal outdoor activity app system of claim 1 wherein said app further includes presenting an outdoor activity query to the subscriber to identify the desired outdoor activity.

4. The personal outdoor activity app system of claim 1 wherein said app is dedicated to one specific outdoor activity.

5. The personal outdoor activity app system of claim 1 wherein said app is dedicated to swimming and the locations are beaches.

6. The personal outdoor activity app system of claim 1 wherein said app is dedicated to skiing and snowboarding and the locations are ski and snowboard areas.

7. The personal outdoor activity app system of claim 6 wherein said app further provides slope conditions with each location.

8. The personal outdoor activity app system of claim 1 wherein said app is dedicated to golfing and the locations are golf facilities.

9. The personal outdoor activity app system claim 1 wherein said weather information includes wind speed and direction for each location.

10. The personal outdoor activity app system of claim 1 wherein said app further includes a selection option enabling a subscriber to select a location to obtain further information selected from the group consisting of at least one of: (1) a telephone number; (ii) a website; (iii) an address; (iv) travel directions; and (v) discount coupon.

11. A personal outdoor activity app system for wireless communications devices, which comprises:
a) providing an app link to subscribers that may be activated by selection of the app;
b) upon activation of the app by a subscriber, identifying the subscriber by receiving a location ID and presenting a distance query to the subscriber that seeks the maximum distance that said subscriber desires to travel, wherein the subscriber may send a selected distance by a method selected from the group consisting of typing a distance, and selecting one of a plurality of offered, preset distances;
c) locating and identifying all outdoor activity locations with the selected distance;
d) procuring weather information relating to each location of an outdoor activity within the selected distance of said subscriber;
e) procuring traffic information relating to each location of an outdoor activity within the selected distance of said subscriber;
f) establishing a weather score for procured weather information for each location and ranking each location in accordance with said weather score;
g) establishing a traffic score for procured traffic information for each location and ranking each location in accordance with said traffic score; and,
h) presenting at least one orderly list of all outdoor activity locations based on one criterion selected from the group consisting of (i) two lists as follows: a separate weather list and a separate traffic list; and (ii) a single list based on combined weather scores and traffic scores; (iii) at least two lists as follows: a separate weather list and a separate traffic list and distance; and (iv) at least a single list based on combined weather scores and traffic scores, and distance.

12. The personal outdoor activity app system of claim 11 wherein said app further includes additional information for each location.

13. The personal outdoor activity app system of claim 11 wherein said app further includes presenting an outdoor activity query to the subscriber to identify the desired outdoor activity.

14. The personal outdoor activity app system of claim 11 wherein said app is dedicated to one specific outdoor activity.

15. The personal outdoor activity app system of claim 11 wherein said app is dedicated to swimming and the locations are beaches.

16. The personal outdoor activity app system of claim 11 wherein said app is dedicated to skiing and snowboarding and the locations are ski and snowboard areas.

17. The personal outdoor activity app system of claim 16 wherein said app further provides slope conditions with each location.

18. The personal outdoor activity app system of claim 11 wherein said app is dedicated to golfing and the locations are golf facilities.

19. The personal outdoor activity app system claim 11 wherein said weather information includes wind speed and direction for each location.

20. The personal outdoor activity app system of claim 11 wherein said app further includes a selection option enabling a subscriber to select a location to obtain further information selected from the group consisting of at least one of: (1) a telephone number; (ii) a website; (iii) an address; (iv) travel directions; and (v) discount coupon.
